(19) United States
(12) Patent Application Publication
(10) Pub. No.: US 2017/0361778 A1
(43) Pub. Date: Dec. 21, 2017

(54) Material tote

(71) Applicant: David Dutka, Suwanee, GA (US)

(72) Inventor: David Dutka, Suwanee, GA (US)

(21) Appl. No.: 14/999,728

(22) Filed: Jun. 20, 2016

(51) Int. Cl. B60R 9/06

(52) U.S. Cl. CPC B60R 9/06

(57) ABSTRACT

An innovative simple device formed or shaped from a rigid material. Shaped in a manner to facilitate the rigid material to lock under the rear quarter panel of a truck bed rail. Providing a means for moving material longer than the truck bed.

### FEDERALLY SPONSORED RESEARCH

Not applicable

### SEQUENCE LISTING OR PROGRAM

Not Applicable

### BACKGROUND—FIELD

This intellectual property relates to a device that facilitates transportation of materials that are longer than storage capacities of most personal vehicles. Personal truck beds are 6 to 8 foot in length. Many construction materials will span 16 feet in length. This device provides a solution.

### SUMMARY

A temporary hauling device that mounts to a pick up truck bed rail. Providing a means of transporting materials longer than standard truck beds.

### DRAWINGS

The present drawings are generic in scope providing an assisted understanding of the present embodiment.

FIG. 1. Is a practical side view showing the shape of the rigid material; enabling the material to lock under the truck bed rail,

FIG. 2. is a practical view from the back showing the intellectual properties general form that enables stability while in position with or without material in place to transport,

FIG. 3. is a practical view with the tool attached to the truck bed quarter panel.

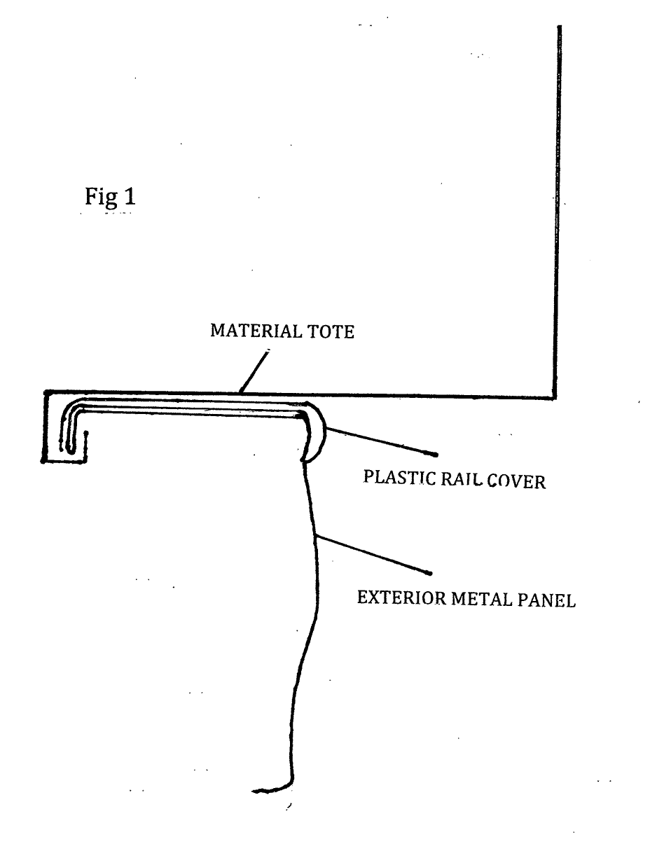

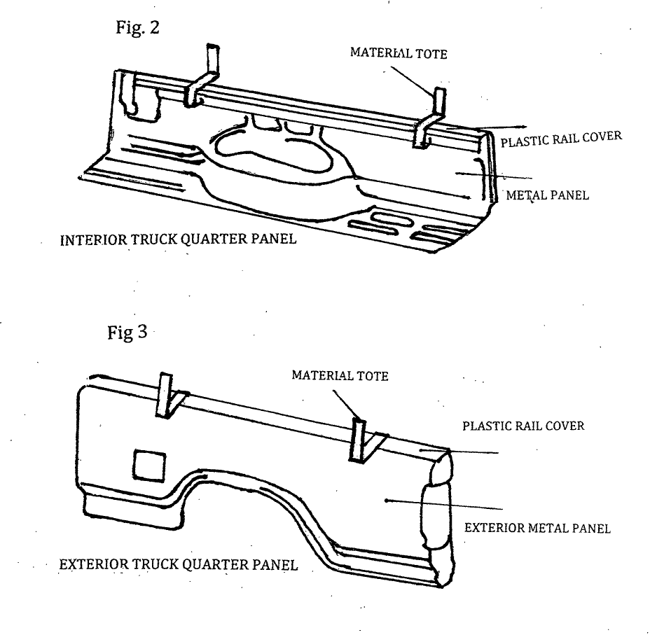

1. A material formed in a flat bar shape; bent or formed; enabling the embodiment to attach to the rear quarter panel of a truck bed rail;

2. The Material Tote tool of claim 1; when attached to the back quarter panel rail of a pick up truck will aid in transportation of objects longer than the truck bed.

3. The Material Tote tool of claim 2; wherein 2 or more Material Tote tools are installed on a truck bed rail; the weight capacity and stability will increase.
